(19) United States
(12) Patent Application Publication
(10) Pub. No.: US 2009/0174672 A1
(43) Pub. Date: Jul. 9, 2009

(54) HAPTIC ACTUATOR ASSEMBLY AND METHOD OF MANUFACTURING A HAPTIC ACTUATOR ASSEMBLY

(76) Inventor: Robert M. Schmidt, Livonia, MI (US)

Correspondence Address: BLANK ROME LLP, WATERGATE, 600 NEW HAMPSHIRE AVENUE, N.W., WASHINGTON, DC, 20037, US

(21) Appl. No.: 11/969,071

(22) Filed: Jan. 3, 2008

(51) Int. Cl. G06F 3/041; H04B 3/36

(52) U.S. Cl. 345/173; 340/407.1

(57) ABSTRACT

A haptic actuator assembly and a method of manufacturing a haptic actuator assembly. The haptic actuator assembly includes a rail of predetermined length and a haptic actuator coupled to the rail, wherein the rail is coupled to another device to provide haptic feedback. The method of manufacturing a haptic actuator assembly includes the steps of providing a rail and coupling a haptic actuator to the rail.

### FIELD OF THE INVENTION

The present invention relates to haptic actuator assemblies in systems for interfacing with electrical and mechanical devices. In particular, the present invention relates haptic actuator assemblies providing haptic feedback for touch screen applications.

### BACKGROUND OF THE INVENTION

A user often has to interface with multiple electrical and mechanical devices to adjust various functions and operations thereof For example, the driver of a car interfaces with a heating and cooling system, an audio entertainment system, windows, locks, maybe a cruise control system and possibly a navigation system. Conventionally, the user would use buttons, switches, knobs, and other similar mechanisms to control various functions or operations of these devices. However, with the increased number of controllable devices, along with the increased complexity of each individual device, the user may be required to provide many different inputs. To replace the many, separate, and different control mechanisms and to simplify and enhance the control of these many devices, a single instrument that can relay commands to several devices is often employed.

One such instrument for controlling several devices is a display interface. By using a display interface, the user adjusts devices by interacting with a hierarchical menu shown on the display to select a particular device and to select a particular function associated with that device. The display interface can include buttons or switches, but it can also be a touchscreen.

To enhance the display interface, visual, auditory, kinesthetic, or tactile cues may be used to provide feedback to the user. Kinesthetic feedback, such as active and resistive force feedback, and tactile feedback, such as vibration, texture, and heat, are collectively referred to as “haptic feedback” herein. Haptic feedback can be used to convey physical force sensations to the user as the user interacts with the display interface. The physical forces may simulate actuating a button or switch and provide the user with an indication that the user's input has been accepted.

Conventional haptic feedback can be provided by linear actuators. Linear actuators provide linear motion upon receiving an electrical command. In one conventional system, four individual linear actuators are placed at the four corners of a display interface. Based on the user's interaction with the display interface, the four individual actuators will simultaneously impart a slight linear motion to the display interface to provide haptic feedback to the user.

However, conventional haptic feedback systems using four individual linear actuators are costly to manufacture and require high precision during assembly. Since four individual linear actuators are needed, the conventional haptic feedback system necessarily costs more to manufacture than a system that uses fewer actuators. Also, to provide optimum haptic feedback, the linear actuators must be precisely aligned to impart force and movement in only one direction.

### SUMMARY OF THE INVENTION

Accordingly, an aspect of the present invention is to provide a haptic actuator assembly that uses fewer haptic actuators, simplifies manufacturing, and reduces costs.

One embodiment of the present invention provides a haptic actuator assembly. The haptic actuator assembly includes a rail of predetermined length and a haptic actuator connected to the rail, wherein the rail is connected to another device to provide haptic feedback.

Another embodiment of the present invention provides a display assembly. The display assembly includes a stationary member, a display device mounted on the stationary member, a moving member disposed adjacent to the stationary member, the moving member being able to move relative to the stationary member, an input device mounted on the moving member, a mechanical coupling configured to allow the moving member to move relative to the stationary member, and a haptic actuator connected to the stationary member and the moving member such that the haptic actuator moves the moving member relative to the stationary member.

Yet another embodiment of the present invention provides a method of manufacturing a haptic actuator assembly. The method of manufacturing includes the steps of providing a rail and connecting a haptic actuator to the rail.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is an exploded perspective of a display assembly with a haptic actuator assembly according to an exemplary embodiment of the present invention;

FIG. 2 is a side elevational view of a haptic actuator assembly according to an exemplary embodiment of the present invention;

FIG. 3 is a side elevational view of a haptic actuator assembly according to another embodiment of the present invention;

FIG. 4 is a side elevational view of a haptic actuator assembly according to yet another embodiment of the present invention;

FIG. 5 is a side elevational view of a haptic actuator assembly according to yet another embodiment of the present invention;

FIG. 6 is a side elevational view of a haptic actuator assembly according to yet another embodiment of the present invention;

FIG. 7 is a front elevational view of a display assembly according to an exemplary embodiment of the present invention;

FIG. 8 is a sectional view of the display assembly illustrated in FIG. 7 taken along line 8-8;

FIG. 9 is a front elevational view of a display assembly according to another embodiment of the present invention;

FIG. 10 is a sectional view of the display assembly illustrated in FIG. 9 taken along line 10-10;

FIG. 11 is a front elevational view of a display assembly according to yet another embodiment of the present invention; and

FIG. 12 is a sectional view of the display assembly illustrated in FIG. 11 taken along line 12-12.

### DETAILED DESCRIPTION OF THE INVENTION

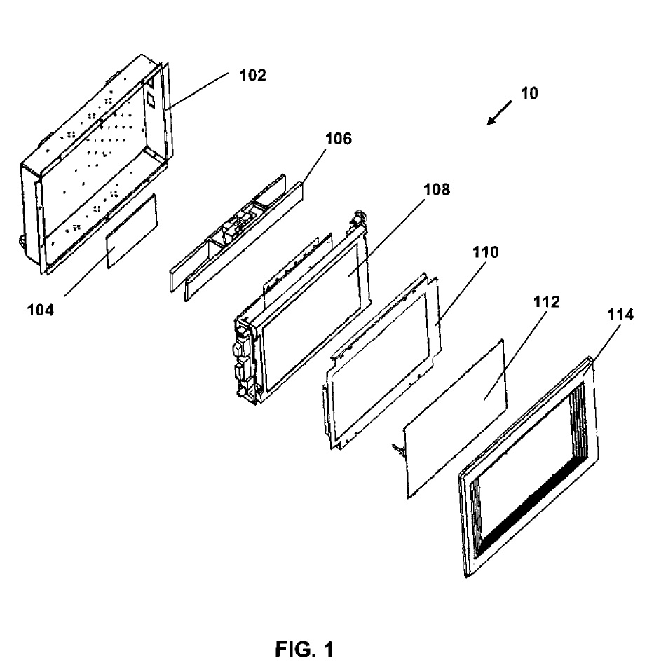

Referring to FIGS. 1 to 12, the present invention relates to a haptic actuator assembly 106 and a method of manufacturing the haptic actuator assembly 106.

Referring to FIG. 1, a display assembly 10 with the haptic actuator assembly 106 is shown. The display assembly 10 includes, at least, the haptic actuator assembly 106 and a display device 108. Although, in the exemplary embodiment depicted, the haptic actuator assembly 106 is used in a display assembly 10, the haptic actuator assembly 106 can be used in any device that provides haptic feedback to the user. The present invention is not limited to only display assemblies. However, to simplify and facilitate the description of the invention, an exemplary embodiment where the haptic actuator assembly 106 is used in a display device 10 will be described.

The haptic actuator assembly 106 provides haptic feedback when the user provides an input in response to the display device 108. In the embodiment depicted, the display assembly 10 includes a touchscreen 112 that overlays the display device 108, and the touchscreen 112 is used to provide an input. Other input devices, such as, but not limited to, touch switches, touch pads, and other similar devices can be used in place of the touchscreen 112. The display device 108 generates graphical images. Preferably, the images are configured to solicit an input from the user. The display device 108 can be, but not limited to, a liquid crystal display (“LCD”), a plasma display, an electroluminescent display, a light emitting diode (“LED”) display such as a display using organic light emitting diodes (“OLED”), or another device for displaying images.

The display assembly 10 can also include a housing 102, a printed circuit board 104, a frame 110, and a cover 114. The housing 102 provides a rigid structure for mounting one side of the haptic actuator assembly 106 so that it can generate a range of lateral forces that produce various sensations. In the embodiment shown, the frame 110 is attached to the touchscreen 112 and coupled mechanically to the haptic actuator assembly 106. The touchscreen 112 is a display overlay which can be either pressure-sensitive (such as by use of resistive sensors), electrically-sensitive (by use of, for example, capacitive sensors), acoustically-sensitive (such as by surface acoustic wave sensors), or photo-sensitive (typically by infrared sensors). Seals can be placed between the touchscreen 112 and the display device 108. The printed circuit board 104 provides power to the haptic actuator assembly 106 and communications with a host system. The cover 114 provides a protective cover for the display assembly 10 and can provide a decorative outer face for the display assembly 10. Additional seals may be placed between the cover 114 and the touchscreen 112.

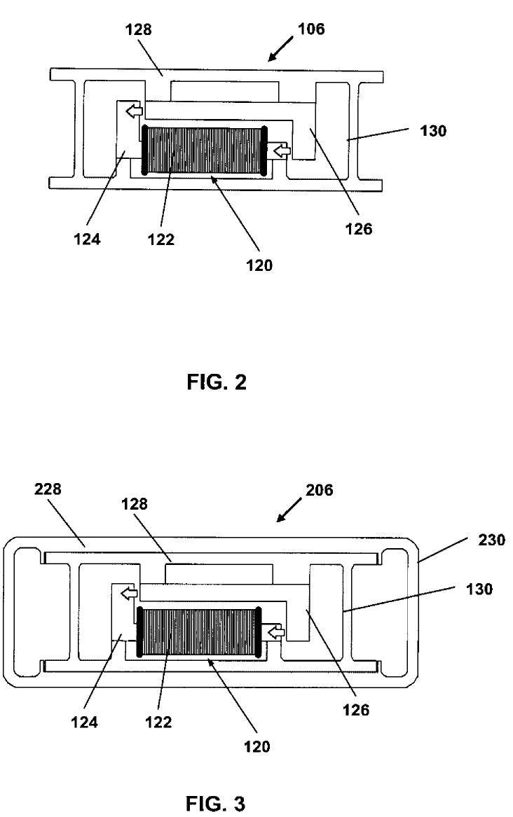

Referring to FIG. 2, the haptic actuator assembly 106 includes a haptic actuator 120, a rail 128, and a connecting member 130. The haptic actuator 120 provides motion, force, vibration, texture, heat, or some other type of tactile feedback. In the embodiment described and shown, the haptic actuator 120 provides linear motion, circular motion, or non-linear motion. The motion can simulate a response to a push of a mechanical button or other similar mechanical input devices. The motion provided by the haptic actuator 120 can be caused by several different methods, such as, but not limited to, electrical, electromechanical, hydraulic, pneumatic, or mechanical. The haptic actuator 120 can be active or passive. Active actuators include, for example, linear current control motors, stepper motors, pneumatic/hydraulic active actuators, voice coil actuators, and other similar devices. Passive actuators include, but are not limited to, dissipative passive actuators, linear magnetic particle brakes, linear friction brakes, pneumatic/hydraulic passive actuators, and other similar devices.

To simplify the description without intending to limit the present invention, the haptic actuator 120 will be described as providing a linear motion caused by an electromagnetic interaction. In the embodiment depicted, the haptic actuator 120 has a coil 122, a core 124, and a ferrous body 126. The coil 122 is made of an electrically conductive material wrapped around the core 124. The coil 122 produces a magnetic field when an electrical current is applied to the coil 122. The core 124 is made of a ferrous material or a material that is magnetized in the presence of a magnetic field. When an electrical current is applied to the coil 122, a magnetic field is developed in the coil 122, and the magnetic field causes the core 124 to be attracted magnetically to a nearby ferrous body 126. In the embodiment depicted, the core 124 and the ferrous body 126 are coupled to opposite rails 128. Alternately, the core 124 or the ferrous body 126 can be coupled to a rail 128, while the counterpart ferrous body 126 or core 124 is coupled to another adjacent structure in the display assembly 10.

The rails 128 are disposed parallel with respect to each other, and the connecting member 130 couples the rails 128 together. Also, the number of connecting members 130 illustrated is exemplary only and is not intended to be limiting. The optimal number of connecting members 130 may be more or less than the number of connecting members 130 depicted in FIG. 2. In the embodiment shown, the core 124 is coupled to one rail 128, and the ferrous body 126 is coupled to an opposite rail 128. Thus, the movement of the core 124 towards the ferrous body 126 causes the opposite rails 128 to move with respect to each other and elastically deforms the connecting member 130. As a result of the core 124 moving towards the ferrous body 126, the haptic actuator assembly 106 elastically deforms linearly. When the electrical current is removed, the magnetic field collapses, and the connecting member 130 elastically returns to its original shape thus pulling the core 124 away from the ferrous body 126 and substantially returning the rails 130 to their original positions with respect to each other.

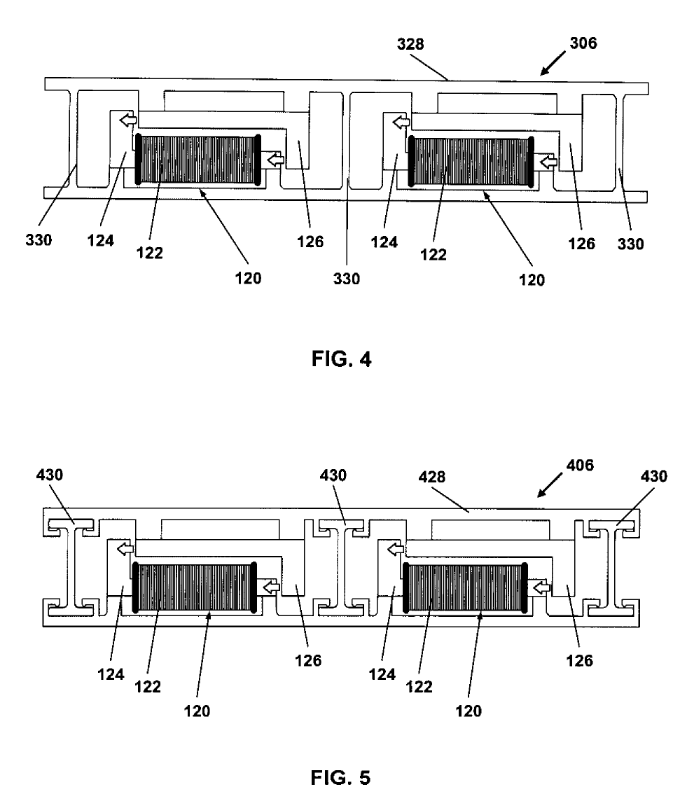

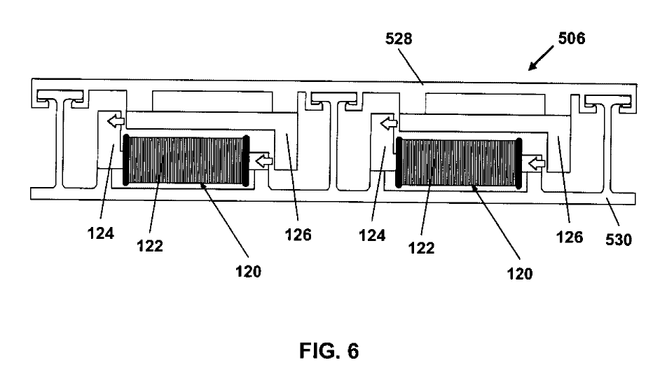

The rail 128 and the connecting member 130 are preferably made of a flexible material, for example, resin, rubber, synthetic rubber, neoprene, plastic, thermoplastic, thermosetting plastic, combinations of the aforementioned, and other similar materials. The rail 128 and the connecting member 130 can be a single-molded assembly, as shown in FIGS. 2 and 4, or a multi-piece assembly, as shown in FIGS. 5 and 6.

Furthermore, a length of the rail 128 can be adjusted or predetermined for a particular application. The rail 128 can be extended or shortened to a particular length to match the length required for a particular application. Also, by providing connecting members 130 at appropriate locations along the length of the rail 128, the length of the rail 128 can be extended without substantial loss of mechanical strength or integrity.

In the embodiment shown in FIG. 2, a single haptic actuator 120 is coupled to the rail 128. By using a single haptic actuator 120, the haptic actuator assembly 106 reduces costs by reducing the number of haptic actuators 120 required in the haptic actuator assembly 106. A single haptic actuator 120 also simplifies manufacturing since only one haptic actuator 120 is manufactured and coupled to the rail 128. Furthermore, a single haptic actuator 120 prevents the problem of inconsistent travel distances among multiple haptic actuators 120. For haptic actuators 120 using electromagnetic interactions, inconsistencies in a core gap, i.e., the distance between the core 124 and the ferrous body 126, results in different travel distances among several haptic actuators 120. Consequently, for the embodiment described, the speed and travel of the linear motion can be diminished. Also, by using a single haptic actuator 120, the placement of the haptic actuator 120 relative to the rail 128 can be predetermined or adjusted for a particular application. Thus, the haptic actuator 120 need not be placed substantially in the center of the flex frame, as shown in FIG. 2.

Referring to FIG. 3, a haptic actuator assembly 206 is shown. Unlike the haptic actuator assembly 106, the haptic actuator assembly 206 has, at least, a second rail 228 and a second connecting member 230 in addition to the haptic actuator 120, the rail 128, and the connecting member 130. The haptic actuator 120, the rail 128, and the connecting member 130 are the same as in the previous embodiment, thus detailed descriptions thereof are omitted. The second rails 228 are disposed parallel to each other and the rails 128. The second connecting members 230 couple the second rails 228 to each other. The second connecting members 230 can be formed integrally with the second rails 228, as shown, or formed separately and coupled to the second rails 228. The number of second connecting members 230 illustrated is exemplary only and is not intended to be limiting. The optimal number of second connecting members 230 may be more or less than the number of second connecting members 230 depicted in FIG. 3.

To obtain desired material properties, such as the force required by the haptic actuator 120 to cause the rails 128 and the second rails 228 to move relative to each other, the second rail 228 and second connecting member 230 are preferably made of a material different from the rail 128 and the connecting member 130. The rail 128, the connecting member 130, the second rail 228, the second connecting member 230, or any combination thereof can be made of two or more resins. The use of two or more resins provides different material properties in different planes of the rail 128, the connecting member 130, the second rail 228, the second connecting member 230, or any combination thereof. In an exemplary embodiment, the rail 128 and the connecting member 130 are made of a thermoplastic resin based on polycarbonate, such as PC Lexan 141, while the second rail 228 and the second connecting member 230 are made of a thermoplastic polyester resin based on polybutylene terephthalate polymer, in particular PBT Valox 310. By forming the rail 128 and the connecting member 130 from PC Lexan 141 and forming the second rail 228 and the second connecting member 230 from PBT Valox 310, the haptic actuator 120 requires more force to cause the rails 128 and second rails 228 to move relative to each other. Also, the haptic actuator assembly 206 is preferably made by insert or two shot molding.

Referring to FIG. 4, a haptic actuator assembly 306 according to yet another embodiment is shown. In the haptic actuator assembly 306, multiple haptic actuators 120 are coupled to a single rail 328. By coupling the haptic actuators 120 to the rail 328, the haptic actuators 120 can be aligned to move in one direction. The haptic actuators 120 are the same as in the previous embodiments, thus a detailed description thereof is omitted. The rails 328 are disposed parallel to each other and connected to one another by connecting members 330. The connecting members 330 can be formed integrally with the rails 328, as shown, or formed separately and coupled to the rails 328, as shown in FIG. 5. The number of haptic actuators 120 and connecting members 330 illustrated is exemplary only and is not intended to be limiting. The optimal number of haptic actuators 120 and connecting members 330 may be more or less than the number of actuators 120 and connecting members 330 shown in FIG. 4.

By coupling multiple haptic actuators 120 to the rail 328, the rail 328 provides alignment to the multiple haptic actuators 120. Separately formed haptic actuators 120 need to be aligned with each other because misaligned haptic actuators 120 can diminish the movement, the speed, and the direction of motion provided by the actuators 120. Thus, by coupling multiple haptic actuators 120 to at least one rail 328, individual haptic actuators 120 do not have to be aligned with each other to ensure that the motion of the haptic actuators 120 will be in a single direction and speed.

Referring to FIG. 5, a haptic actuator assembly 406 according to yet another embodiment is shown. Unlike the haptic actuator assembly 106, the haptic actuator assembly 406 has rails 428 and connecting members 430 formed separately. The haptic actuator assembly 406 includes, at least, the haptic actuator 120, the rail 428, and the connecting member 430. The haptic actuator 120 is the same as in the previous embodiment, thus a detailed description thereof is omitted. The rails 428 are disposed parallel to each other and connected to one another by separately formed connecting members 430. The connecting members 430 are coupled to the rail 428 mechanically, such as by the example shown in FIG. 5, press fitting, latches, clasps, hooks, fasteners, welding, combinations of the aforementioned, or other similar mechanical couplings. Alternately, the connecting members 430 can be coupled chemically to the rails 428 by, for example, use of an adhesive. Also, the number of haptic actuators 120 and connecting members 430 illustrated is exemplary only and is not intended to be limiting. The optimal number of haptic actuators 120 and connecting members 430 may be more or less than the number of actuators 120 and connecting members 430 shown in FIG. 5.

Referring to FIG. 6, a haptic actuator assembly 506 according to yet another embodiment is shown. Unlike the haptic actuator assembly 106, the haptic actuator assembly 506 has an integrated rail and connecting member 530 that has a rail and a connecting member formed integrally with each other.

The haptic actuator assembly 506 includes, at least, the haptic actuator 120, the rail 528, and the integrated rail and connecting member 530. The haptic actuator 120 is the same as in the previous embodiment, thus a detailed description thereof is omitted. The rail 528 is disposed parallel to the integrated rail and connecting member 530. The rail 528 and the integrated rail and connecting member 530 are coupled to each other. The rail 528 and the integrated rail and connecting member 530 can be coupled to one another mechanically, such as by the example shown in FIG. 6, press fitting, latches, clasps, hooks, fasteners, welding, combinations of the aforementioned, or other similar mechanical couplings. Alternately, the integrated rail and connecting member 530 can be coupled to the rail 528 by, for example, using an adhesive. Also, the number of haptic actuators 120 and couplings illustrated is exemplary only and is not intended to be limiting. The optimal number of haptic actuators 120 and couplings may be more or less than the number of actuators 120 and couplings shown in FIG. 6.

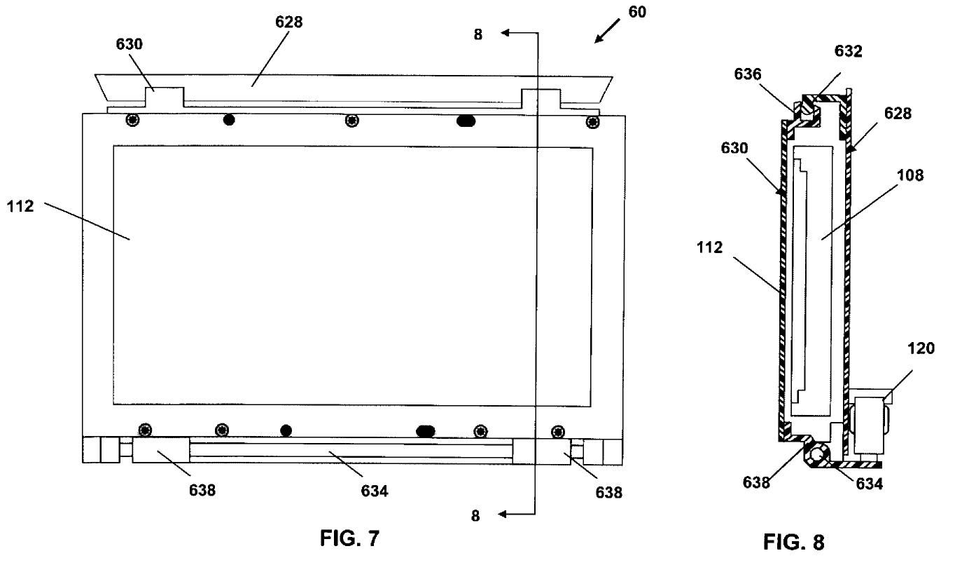

Referring to FIGS. 7 and 8, a display assembly 60 is shown. The display assembly 60 includes, at least, a stationary member 628, a moving member 630 placed adjacent to the stationary member 628, and the haptic actuator 120 connected to the stationary member 628 and the moving member 630.

In the embodiment depicted, the display assembly 60 also includes the display device 108 and the touchscreen 112. The display device 108 is placed between the stationary member 628 and the moving member 630, and the touchscreen 112 is mounted on the moving member 630. Thus, the user can provide an input on the touchscreen 112 in response to requests displayed on the display device 108 placed behind the touchscreen 112. In alternate embodiments, the display device 108 can be mounted on the stationary member 628, on the moving member 630 with the touchscreen 112, or some other structure of the display assembly 60.

In the embodiment depicted, the display assembly 60 includes a single haptic actuator 120. The haptic actuator 120 is the same as in previous embodiments, thus a detailed description thereof is omitted. Also, in alternate embodiments, there can be more than one haptic actuator 120. The haptic actuator 120 is separately formed and then coupled to the stationary member 628 and the moving member 630. The coupling can be mechanical, or the haptic actuator 120 can be coupled by using an adhesive or another type of coupling.

The moving member 630 moves relative to the stationary member 628. Also, the moving member 630 is mechanically coupled to the stationary member 628. In the embodiment shown, there are two mechanical couplings. One mechanical coupling includes a track 632 and a traveling member 636 that travels along the track 632. The other mechanical coupling has a bar 634 and a sliding member 638 that travels along the bar. Also, in the embodiment shown, the track 632 and the bar 634 are disposed on the stationary member 628. The traveling member 636 and the sliding member 638 are disposed on the moving member 630. Thus, when the haptic actuator 120 provides motion to the moving member 630, the traveling member 636 of the moving member 630 travels along the track 632 of the stationary member 628, and the sliding member 638 of the moving member 630 travels along the bar 634 of the stationary member 630. Furthermore, although the embodiment shown includes the track 632, the traveling member 636, the bar 634, and the sliding member 638, in alternate embodiments, the present invention can incorporate other mechanical couplings that allow the moving member 630 to move relative to the stationary member 628.

The track 632 and the traveling member 636 can be provided at top portions of the stationary member 628 and the moving member 630, respectively, as shown in FIG. 8, or at bottom portions of the stationary member 628 and the moving member 630. Similarly, the bar 634 and the sliding member 638 can be provided at the top portions or bottom portions (as shown in FIG. 8) of the stationary member 628 and moving member 630.

Also, the track 632 can be provided on either the stationary member 628 or the moving member 630, with the traveling member 636 consequently provided on either the moving member 630 or the stationary member 628 to engage the track 632. Similarly, the bar 634 can be provided on either the stationary member 628 or the moving member 630 with the sliding member 638 on either the moving member 630 or the stationary member 628 to engage the bar 634.

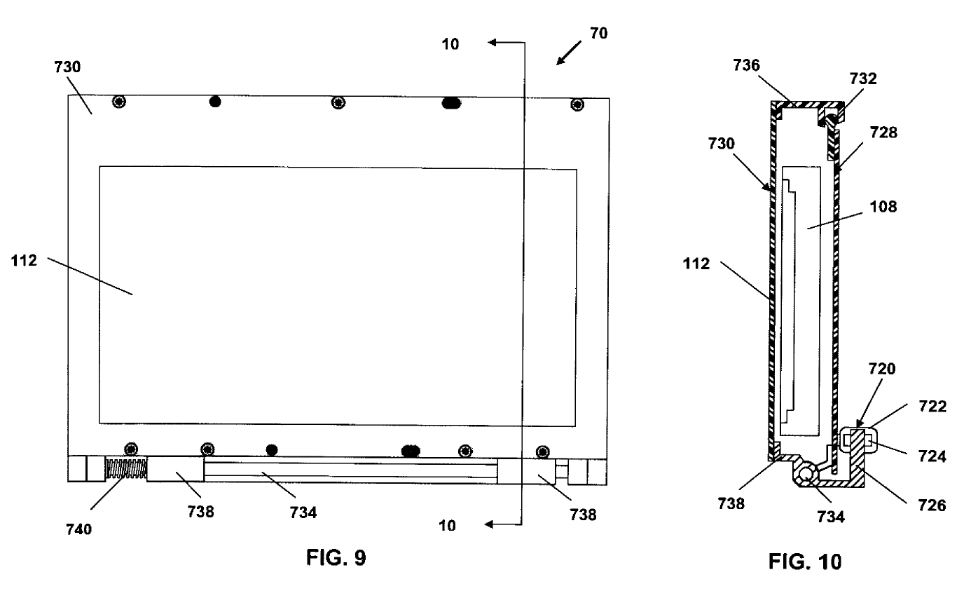

Referring to FIGS. 9 and 10, a display assembly 70 is shown. Unlike the display assembly 60, the display assembly 70 includes a haptic actuator 720 that is integrated with at least the stationary member 728 or the moving member 730.

In the embodiment depicted, similar to display assembly 60, the display assembly 70 includes the display device 108 and the touchscreen 112. The display device 108 is placed between the stationary member 728 and the moving member 730. However, unlike display device 60, the touchscreen 112 is mounted within the moving member 730. Thus, the user can provide an input on the touchscreen 112 in response to requests displayed on the display device 108 placed behind the touchscreen 112. In alternate embodiments, the display device 108 can be mounted on the stationary member 728, on the moving member 730 with the touchscreen 112, or some other structure of the display assembly 70.

Unlike display assembly 60, the display assembly 70 includes an integrated haptic actuator 720. In alternate embodiments, there may be more than one haptic actuator 720. Although other types of haptic actuators may be used, to simplify and facilitate the description, the haptic actuator 720 will be described as an electrically actuated haptic actuator that provides linear motion. Thus, the haptic actuator 720 includes a coil 722, a core 724, and a ferrous body 726. In the embodiment depicted, the core 724 is integrated with the stationary member 728, and the ferrous body 726 is integrated with the moving member 730. In alternate embodiments, the core 724 can be integrated with the moving member 730, and the ferrous body 726 can be integrated with the stationary member 728. The coil 722 is wrapped around the core 724 and is made of an electrically conductive material. The coil 722 produces a magnetic field when an electrical current is applied to the coil 722. The core 724 is made of a ferrous material or a material that is magnetized in the presence of a magnetic field. When an electrical current is applied to the coil 722, a magnetic field is developed in the coil 722, and the magnetic field causes the core 724 to be attracted magnetically to a nearby ferrous body 726. The movement of the core 724 towards the ferrous body 726 causes the moving member 730 to move relative to the stationary member 728. When the electrical current is removed, the magnetic field collapses, and a spring member 740 elastically returns the moving member 730 substantially to its original starting position and pulls the core 724 away from the ferrous body 726.

The moving member 730 moves relative to the stationary member 728. In the embodiment shown, the stationary member 728 includes a track 732 and a bar 734, and the moving member 730 includes a traveling member 736 that engages the track 732 and a sliding member 738 that engages the bar 734. The track 732, the traveling member 736 that moves along the track 732, the bar 734, and the sliding member 738 that moves along the bar 734 are substantially the same as the track 632, the traveling member 636, the bar 634, and the sliding member 638, respectively, described above. Thus, a detailed description thereof is omitted. Other types of mechanical couplings that allow the moving member 730 to move relative to the stationary member 728 can be used instead of the track 732, the traveling member 736, the bar 734, and the sliding member 738.

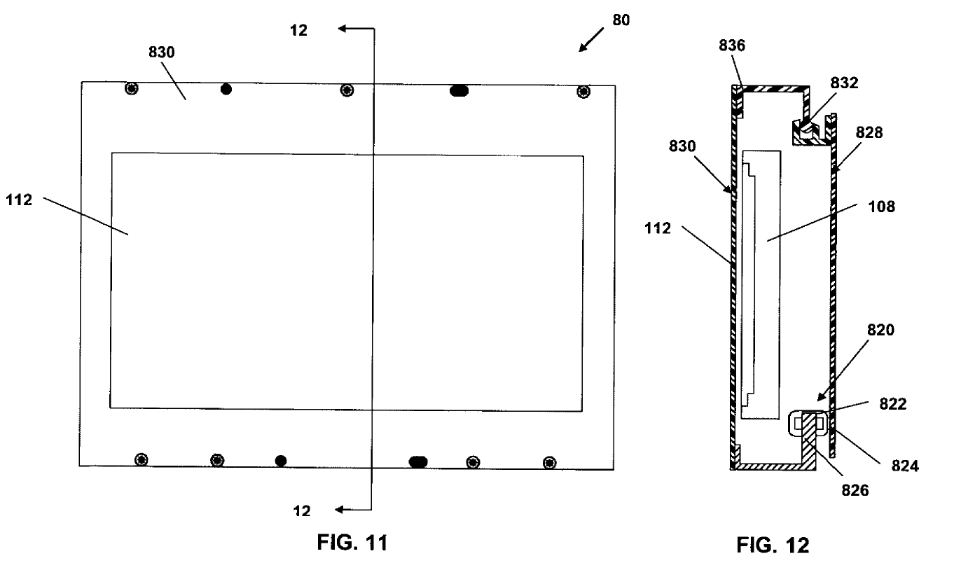

Referring to FIGS. 11 and 12, a display assembly 80 is shown. Unlike the display assembly 60 or 70, the display assembly 80 has a moving member 830 that substantially wraps around the display device 108. Also, in the embodiment depicted, the haptic actuator 820 is integrated with a stationary member 828 and the moving member 830. Furthermore, the embodiment shown only has a track 832 and a traveling member 836.

In alternate embodiments, there may be more than one haptic actuator 820. The haptic actuator 820 is substantially similar to haptic actuator 720, and thus a detailed description thereof is omitted.

The haptic actuator 820 causes the moving member 830 to move relative to the stationary member 828. The moving member 830 includes the track 832, and the stationary member 828 includes the traveling member 836. In an alternate embodiment, the track 832 can be disposed at the stationary member 828, and the traveling member 836 can be disposed at the moving member 830. The track 832 and the traveling member 836 are substantially identical to the track 632 and the traveling member 636 described above. Therefore, a detailed description is omitted. Also, other mechanical couplings that allow the moving member 830 to move relative to the stationary member 828 can be used in place of the track 832 and the traveling member 836.

To describe the operation of the haptic actuator assembly according to one implementation, the following exemplary embodiment is provided and described in detail with reference to FIGS. 1 and 2. However, the invention is not intended to be limited to the following exemplary embodiment. The exemplary embodiment of the display assembly 10 will be described as if the assembly 10 was mounted in the dashboard of a car, and in particular, the housing 102 is mounted to the dashboard. The user of the assembly 10 will be the driver of the car.

If, for example, the driver wants to adjust the temperature setting of the car's air conditioner, the driver will examine the display device 108 which has an image showing selections for controlling various devices of the car, including the air conditioner. Placed over the display device 108 is the frame 110, and mounted on the frame 110 is the touchscreen 112. The driver can view the image on the display device 108 through the touchscreen 112. The driver locates on the image the selection for setting the temperature of the air conditioner and touches the touchscreen 112 near that selection. The touchscreen 112 processes the physical touch of the driver into an electrical signal. The electrical signal is sent to the printed circuit board 104 to relay the selection to the temperature controller of the car's air conditioner. Also, the printed circuit board 104 sends a signal to the haptic actuator assembly 106.

The signal is received by the haptic actuator 120 of the haptic assembly 106. The haptic actuator 120 depicted has a core 124 attached to a rail 128, a coil 122 wrapped around the core 124, and a ferrous body 126 attached to an opposite rail 128, as shown in FIG. 2. One rail 128 of the haptic actuator assembly 106 is coupled to the housing 102, and the opposite rail 128 is coupled to the frame 110. The signal from the printed circuit board 104 is applied to the coil 122 which causes the coil 122 to produce a magnetic field. The magnetic field causes the core 124 to be attracted to the ferrous body 126. Because the core 124 and ferrous body 126 are coupled to opposite rails 128, the movement of the core 124 towards the ferrous body 126 causes the rails 128 to move with respect to each other. Because the haptic actuator assembly 106 is coupled to the housing 102 and the frame 110, and the housing 102 is mounted to the dashboard, the frame 110 moves slightly in one direction. Then, the printed circuit board 104 removes the signal to the haptic actuator assembly 106. When the signal is removed, the magnetic field collapses, and the haptic actuator assembly 106 elastically returns to its original shape thus pulling the core 124 away from the ferrous body 126 and substantially returning the rails 130 to their original positions with respect to each other. Thus, the frame 110 moves in one direction and then moves in the opposite direction to return to its original position. The slight back and forth movement of the frame 110 provides a haptic feedback to the driver to acknowledge that his selection of temperature control has been accepted by the display assembly 10. As the driver enters more selections on the touchscreen 112, the frame 110 moves back and forth again to acknowledge each accepted selection.

As apparent from the above description, the present invention provides a haptic actuator assembly and a method of manufacturing a haptic actuator assembly. At least one haptic actuator is coupled to a rail to provide haptic feedback. Because only one haptic actuator can be used, fewer haptic actuators are required than conventional haptic feedback systems. Also, by using one haptic actuator, the haptic actuator assembly costs less and simplifies manufacturing. Furthermore, in embodiments which have more than one haptic actuator, the rail provides alignment to multiple haptic actuators. Accordingly, the present invention uses fewer haptic actuators, simplifies manufacturing, and reduces costs.

While a particular embodiment has been chosen to illustrate the invention, it will be understood by those skilled in the art that various changes and modifications can be made therein without departing from the scope of the invention as defined in the appended claims.

What is claimed is:

1. A haptic actuator assembly, comprising:
a rail of predetermined length; and
a haptic actuator coupled to the rail,
wherein the rail is coupled to another device to provide haptic feedback.

2. The haptic actuator assembly of claim 1, wherein the haptic actuator provides linear motion.

3. The haptic actuator assembly of claim 1, wherein the haptic actuator is actuated by an electrical signal.

4. The haptic actuator assembly of claim 1, wherein the haptic actuator further comprises:
a core coupled to the rail;
a coil wrapped around the core; and
a ferrous body disposed adjacent to the core and coupled to a second rail coupled to the rail.

5. The haptic actuator assembly of claim 1, wherein the haptic actuator is integrally formed with the rail.

6. The haptic actuator assembly of claim 1, wherein the haptic actuator further comprises a plurality of haptic actuators.

7. The haptic actuator assembly of claim 6, wherein the plurality of haptic actuators are aligned in one direction by coupling to the rail.

8. The haptic actuator assembly of claim 1, further comprising a second rail coupled to the haptic actuator.

9. The haptic actuator assembly of claim 8, wherein the rail and the second rail are coupled to each other by connecting members.

10. The haptic actuator assembly of claim 1, wherein a position of the haptic actuator relative to the rail is adjustable.

11. A display assembly, comprising:
a stationary member;
a display device mounted on the stationary member;
a moving member disposed adjacent to the stationary member, the moving member being able to move relative to the stationary member;
an input device mounted on the moving member;
a mechanical coupling configured to allow the moving member to move relative to the stationary member; and
a haptic actuator coupled to the stationary member and the moving member such that the haptic actuator moves the moving member relative to the stationary member.

12. The display assembly of claim 11, wherein the haptic actuator provides linear motion.

13. The display assembly of claim 11, wherein the haptic actuator is actuated by an electrical signal.

14. The display assembly of claim 11, wherein the haptic actuator further comprises:
a core coupled to the moving member;
a coil wrapped around the core; and
a ferrous body disposed adjacent to the core and coupled to the stationary member.

15. The display assembly of claim 11, wherein the haptic actuator further comprises:
a core coupled to the stationary member;
a coil wrapped around the core; and
a ferrous body disposed adjacent to the core and coupled to the moving member.

16. The display assembly of claim 11, wherein the haptic actuator is integrally formed with the stationary member.

17. The display assembly of claim 11, wherein the haptic actuator is integrally formed with the moving member.

18. The display assembly of claim 11, wherein the haptic actuator further comprises a plurality of haptic actuators.

19. The display assembly of claim 18, wherein the plurality of haptic actuators are aligned in one direction by coupling to at least one of the frame or the mount.

20. A method of manufacturing a haptic actuator assembly, comprising the steps of:
providing a rail with a predetermined length; and
coupling a haptic actuator to the rail.

21. The method of manufacturing of claim 20, further comprising the step of coupling the rail to a device to provide haptic feedback.

22. The method of manufacturing of claim 20, further comprising the step of coupling an additional haptic actuator to the rail such that the rail aligns the haptic actuator and the additional haptic actuator.

23. The method of manufacturing of claim 20, wherein the haptic actuator provides linear motion.

24. The method of manufacturing of claim 20, further comprising the step of applying an electrical signal to actuate the haptic actuator.

25. The method of manufacturing of claim 20, wherein the haptic actuator further comprises:
a core coupled to the rail;
a coil wrapped around the core; and
a ferrous body disposed adjacent to the core and coupled to a second rail coupled to the rail.

26. The method of manufacturing of claim 20, further comprising the step of integrally forming the haptic actuator with the rail,

27. The method of manufacturing of claim 20, further comprising the steps of:
providing a second rail parallel to the rail; and
coupling the second rail to the haptic actuator and the rail.
